(19) United States
(12) Patent Application Publication
(10) Pub. No.: US 2008/0281013 A1
(43) Pub. Date: Nov. 13, 2008

(54) Polyurethane Resin and a Process for the Production Thereof

(75) Inventors: Masafumi Nakamura, Suita City (JP); Fumihiko Noda, Nishinomiya-City (JP); Shinichiro Sado, Niihama-City (JP)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/117,863

(22) Filed: May 9, 2008

(30) Foreign Application Priority Data
May 9, 2007 (JP) 2007-124683

(51) Int. Cl. C08G 18/00

(52) U.S. Cl. 521/164; 521/170

(57) ABSTRACT

Reduced aldehyde emissions during heated storage of a polyurethane resin are obtained by including at least one sulfurous compound selected from the group consisting of hydrogen sulfites and disulfites in the polyol component from which that polyurethane is produced. The amount of the sulfurous compound added is generally from 0.02 to 2.0 parts by weight for every 100 parts by weight of the polyol component.

### BACKGROUND OF THE INVENTION

The present invention relates to a method for the production of polyurethane resins in which emission of formaldehyde and acetaldehyde is suppressed and to a molded part produced from such polyurethane.

Polyurethane resins in the form of foam include flexible polyurethane foams, rigid polyurethane foams, and semi-rigid polyurethane foams. Such foams are often used in applications as a molded part although they are sometimes used as it is cut. Examples of polyurethane foam applications include cushions for house furniture, various kinds of car applications (for example, interior parts such as cushions, armrests, steering wheels, change knobs, ceiling material, instrument panel and door trim structural material), synthetic woods, appliances, and heat-insulating materials for buildings.

A solid polyurethane resin can be a polyurethane elastomer or a rigid urethane structural object. Solid polyurethanes are used for electrical parts (for example, paper feed roller of copier), synthetic woods or heat insulating members such as heat-insulating aluminum sashes.

A polyurethane resin is obtained by blending and reacting a mixture containing one or more polyols, a catalyst, a crosslinker, if needed, a blowing agent, a surfactant, reinforcing materials and other auxiliaries (hereinafter collectively referred to as a polyol mixture) and a polyisocyanate compound, each of which is selected on the basis of product requirements such as a physical property for a particular application field, reactivity and moldability.

In forming a polyurethane resin, a polyisocyanate compound and a polyol mixture are blended in a predetermined ratio of isocyanate equivalents in the polyisocyanate compound to an average of the equivalents of active hydrogen groups present in the isocyanate-reactive material(s) in a polyol mixture, such as OH groups, primary or secondary amine groups, or water. Usually the blending ratio of polyisocyanate and polyol mixture can be determined so that polyisocyanate ratio will be 0.8 to 3.0 equivalents for each equivalent of isocyanate-reactive groups present in the polyol component.

A polyurethane resin can easily be formed into a foam by including a blowing agent in a polyol mixture. Because the raw materials used to produce the polyurethane-forming reaction mixture are liquid, it is relatively easy to add a reinforcing material or a filler to the raw material(s).

Volatile organic compounds (VOC) present problems such as sick house syndrome are encountered with various plastics produced from formaldehyde as a raw material (e.g., a urea resin, melamine resin, phenol resin or polyacetal resin) and from wooden boards used in building materials which are produced with such resins as a binder.

Aldehydes, particularly formaldehyde and acetaldehyde, have been designated by WHO as harmful substances. Guidelines issued by WHO and Heath, Labor and Welfare Ministry, provide that the concentration standards of formaldehyde and acetaldehyde should be 100 μg/m3 [0.08 ppm (vol/vol)] or less, and 48 μg/m³ (0.03 ppm) or less, respectively.

A polyurethane resin has not been thought to be a source of aldehyde emissions because aldehydes are not used as a raw material in their production. To test this assumption, the present inventors measured (using a Kitagawa type detector for formaldehyde (No. 171SC)) the concentration of aldehyde (including acetaldehyde) at 25° C. emitted from 10 to 60 g of various polyurethane foams (including rigid and flexible polyurethane foams) which after 3 days of forming were loaded in a 5-liter container and allowed to stand at 25° C. for 7 days. The aldehyde concentration detected was only 0.6 ppm at maximum [amount of aldehyde released (in terms of formaldehyde) per 1 g of polyurethane foam: 0.026 μg]. Since 6 kg of polyurethane foam in 10 m³ of air at 25° C. in a sealed condition corresponds to only 0.01 ppm in aldehyde concentration, polyurethane foam used at normal temperature is hardly a significant source of aldehyde emission.

VOC problems in a building application where the polyurethane is generally maintained at a normal temperature are different from those where a polyurethane resin is used in an automotive application. For example, when a driver gets in a car that has been sealed in the summer at high temperature, there may be an irritating smell, or an eye irritant. The need for suppression of generation/release of aldehydes or the capture aldehydes under such conditions is different from that for building applications. For instance, typical polyurethane molded parts used in the interior of a car include: a flexible urethane foam used in a seat cushion, a semi-rigid polyurethane foam used in an instrument panel or core pad of interior trims, or a semi-rigid integral skin urethane molded part applied for steering wheels with a relatively high density (about 0.5 g/cm³), or a rigid integral skin urethane molded part reinforced with glass fiber etc. as a backup material for a door trim, or a headliner by hot press molding of a sheet cut rigid urethane foam core and glass fiber mat reinforcement with adhesive for both sides.

The present inventors studied the amount of aldehyde released at 65° C. by various kinds of polyurethane flexible and rigid foams used in a variety of applications after 3 days subsequent to formation in order to examine whether a polyurethane resin is a cause of generation (release) of aldehydes in a high temperature condition. A polyurethane molded part was put in a Tedlar bag, sealed with nitrogen, after being stored at 65° C. for 2 hours, the amounts of formaldehyde and acetaldehyde released from the sample were measured. 4 L of nitrogen in 10 L of Tedlar bag were collected in an aldehyde collection cartridge (DNPH), analyzed by a high-speed liquid chromatography (HPLC) to measure aldehyde emission from the sample. As a result, the level of the amount released varied depending on the kind of polyurethane foam, and it was in a range of 0.01 to 0.13 μg/g as formaldehyde, and 0.01 to 0.15 μg/g as acetaldehyde per 1 g of polyurethane foam.

Generally, to obtain a polyurethane molded part, polyols with various functionalities and molecular weights, a catalyst and a polyisocyanate compound are used as essential components, a crosslinker, a surfactant, blowing agent and the like are optionally used, depending on the desired application. The present inventors studied where aldehydes such as formaldehyde and acetaldehyde released by heating are derived from by addition of DNPH to each component of a foam-forming mixture and analysis thereof by HPLC. As a result, it was confirmed that although aldehyde content of foams produced with a long chain polyether polyol having a molecular weight of at least 2000 is about 1 to 2 ppm or less. In foams produced with a short chained polyether polyol having a molecular weight of about 500, particularly amine-based polyols, formed by addition of EO or PO, 4 to 10 ppm of aldehydes were contained therein. Almost all of the amine catalysts essential for a polyurethane resin molding contain several hundred ppm of aldehydes. In at least one polyol mixture formulated for a polyurethane resin molding, the formaldehyde content reached 10 ppm, and the acetaldehyde content reached 12 ppm. From the target reduction level of aldehydes emission, since aldehydes of even several ppm is a level which cannot be ignored, it is very difficult to eliminate aldehydes from each raw material component to be used.

In raw materials used to produce a polyurethane resin, each raw material component which might contain aldehydes is often essential to the production of the polyurethane. It seems apparent that when development of a polyurethane resin most suitable for a given application is limited by the need to exclude certain raw materials, that development work is severely restricted.

Further, from the removal of aldehydes from each raw material by vacuum and heating these raw materials, it was learned that there was a possibility of generating acetaldehyde when polyether polyol was exposed to temperatures of 100° C. or higher for a long time. On the other hand, a urethane reaction for obtaining a polyurethane part is an exothermic reaction. The temperature of a part being molded rises markedly during production, The temperature at the center of a molded part easily reaches 100° C., thus there is a possibility of generating acetaldehyde etc. during production of a polyurethane molded part. Therefore, it does not directly lead to reduction of the amount of aldehydes emission from polyurethane to remove aldehydes from a polyether polyol itself.

For wooden boards used as a building material produced with an amino resin adhesive, various studies to reduce the aldehyde concentration in living space have been carried out. Inclusion of a so-called aldehyde capturing agent, an odor eliminating agent for indoor application, or the like in the resin has been proposed.

For example, Japanese Unexamined Patent Publication No. JP-A-Sho 49-6606 (1974), discloses a method for removing formaldehyde from a formaldehyde-containing woody material. In this application, there is described a report that application of an aqueous solution containing urea and sodium sulfite to a woody material having the amount of aldehyde generation of 18 ppm, reduced the amount of formaldehyde generation to 0.8 ppm. Urea, urea derivatives, thiourea and thiourea derivatives are exemplified as chemical substances for fixing formaldehyde. These materials react with formaldehyde to produce methylol urea. Sulfites, sodium sulfite, calcium sulfite, sodium hydrogen sulfite, calcium hydrogen sulfite, potassium hydrogen sulfite, sodium pyrosulfite and potassium pyrosulfite are also exemplified as chemical substances for fixing formaldehyde. For example, sodium sulfite reacts with formaldehyde to form sodium hydroxysulfonate and formaldehyde is fixed, which is explained in the specification.

Japanese Unexamined Patent Publication No. JP-A-Sho 50-43181 discloses that in order to reduce formaldehyde emission (release) from a particle board produced with an amino resin binder, a powdery urea was coated on the surface of the board. The amount of formaldehyde generation was reduced to 3.5 ppm from 50 ppm. A formaldehyde catcher is also described. In addition to urea, there are exemplified amines, amino group-containing compounds, ammonium salts, various oxidizing agents and reducing agents.

Similarly, Japanese Unexamined Patent Publication No. JP-A-H 06-293009 (urea, ammonium acetate, ammonium sulfite, sulfite of soda, thiosemicarbazide, ethylenediamine, natural protein), Japanese Unexamined Patent Publication No. JP-A-H 11-240002 (sulfite is added to prevent metal corrosion by urea), and Japanese Unexamined Patent Publication No. JP-A-2004-181045 (double salt of bisulfite), each teach aldehyde catchers directly coated on a board to reduce the release of formaldehyde from a resin containing formalin as a raw material in an adhesive for a woody board. Basically, any chemical substance whose reaction with aldehyde was confirmed can be thought to provide the desired effect to some extent.

Use of an aldehyde-capturing material for an application other than wood boards, is disclosed in Japanese Unexamined Patent Publication No. JP-A-H03-262533. In this application, an aldehyde-capturing material for an air cleaner containing an ion-exchange fiber is disclosed. According to its teachings, any gap material having an —NH₂ group added thereto which is capable of reacting with aldehyde, and an active carbon and/or dextrin may be used. Examples of suitable materials listed include: amines, hydrazines, amides, ureas, and an amino compound having an —NH₂ group capable of reacting with aldehyde.

In Japanese Unexamined Patent Publication Nos. JP-A-H 09-28778 and JP-A-H 09-78452, it is taught bad-smelling components including acetaldehyde are absorbed using as an odor eliminating agent and odor eliminating fiber such as chitosan, hydrazide, polyallylamine and polyethyleneimine as a compound containing a primary amine in a molecule. In an example, dihydrazide adipate is used.

The above-described aldehyde absorbing techniques are also disclosed in Japanese Unexamined Patent Publication No. JP-A-H 04-345648 (a hydrazide compound is added to a polyacetal resin to reduce formaldehyde smell), Japanese Unexamined Patent Publication No. JP-A-H10-36681 (a synthetic resin containing a hydrazide compound of 2-20 parts by weight as a resin composition for absorbing formaldehyde and acetaldehyde), and Japanese Unexamined Patent Publication No. JP-A-H10-36524 (a compound having a hydrazino group or hydrazono group is added to a packing material to pack a resin which generates aldehyde). The addition of hydrazine derivatives is the central to the techniques described in all of these patents.

On the other hand, there are conventional techniques for dealing with aldehyde in a polyurethane resin. Such techniques are disclosed in the prior art.

For example, Japanese Unexamined Patent Publication No. JP-A-2004-339481 discloses production of a polyurethane resin with a low compression residual strain in which the contents of formaldehyde and acetaldehyde in polyol components of raw material are 2 ppm or less, and 3 ppm or less, respectively. To reduce aldehyde in a polyol, a polyol contains a boron atom or a polyol treated with boron.

Japanese Unexamined Patent Publication No. JP-A-2005-48174 discloses production of polyurethane foam with a low content of aldehyde, i.e., the total formaldehyde and acetaldehyde content in the polyol raw material is 8 ppm or less. To reduce aldehyde in a polyol, treatment with a reducing agent or adsorption is described. Examples of the reducing agent listed are metal hydrides such as NaBH4 and LiAH4, inorganic hydrogen-ammonium compound, and MHSO3. In an example therein, only NaBH4 treatment is mentioned as a treatment with a reducing agent.

In these conventional techniques, aldehydes are eliminated from the polyol raw material. However, even in a polyurethane foam produced by using a polyol from which aldehydes were eliminated, aldehydes are sometimes emitted because aldehydes can be generated in a production/reaction stage of polyurethane foam or when heated after production.

Japanese Unexamined Patent Publication No. JP-A-2005-154599 discloses production of polyurethane foams with a reduced amount of volatile aldehyde by adding an aqueous reducing agent dissolved in water to the premixed component containing a polyol, a surfactant and water. Examples of the reducing agent are sodium boron hydride, aluminum lithium hydride, sodium thiosulfate, sodium sulfite, hydrazine compound, ascorbic acid and reduction sugar. The reducing agent is added in amount of from 0.001 to 0.01%. The amount of a reducing agent added is so small in this technique that a sufficient result cannot be obtained.

### SUMMARY OF THE INVENTION

It is an object of the present invention to reduce the amount of aldehyde emissions from a molded polyurethane part.

It is also an object of the present invention to reduce the amount of aldehydes released per 1 g of polyurethane resin at 65° C. for 2 hours to 0.1 μg or less, preferably 0.05 μg or less, more preferably 0.01 μg or less, and most preferably 0.005 μg or less.

These and other objects which will be apparent to those skilled in the art are accomplished by including a hydrogen sulfite or disulfite in the polyol component used to produce the polyurethane.

### DETAILED DESCRIPTION OF THE INVENTION

The density of a polyurethane foam molded part differs greatly depending on its application. In a formulation of raw materials to form a molded part in actual use, for example, a molded part such as seat cushion, installment panel or wheel, a sample with almost same thickness as the molded part actually used is prepared in a predetermined density, and the resulting molded part is cut to 10 cm square. The present invention reduced the amount of aldehydes emitted from the sample at 65° C. for 2 hours to 0.1 μg or less, preferably 0.5 μg or less, and more preferably 0.3 μg.

Where a molded part is used in a thickness of 10 cm or more, the molded part is cut to 10 cm in thickness to be measured. The density of a molded part may be from 0.03 g/cm³ to 1.8 g/cm³. Further, the thickness may be from 0.01 mm to 20 cm. The present invention results in a reduction in the amount of aldehydes emission from per 1 g of such polyurethane resin at a higher temperature, for example, 80° C. for 2 hours to 0.3 μg or less, preferably 0.1 μg or less, and more preferably 0.01 μg or less.

The present invention relates to a process of the production of a polyurethane resin from a polyol mixture containing a polyol and a catalyst, and a polyisocyanate component wherein at least one sulfurous compound selected from the group consisting of hydrogen sulfites and disulfites is added to the polyol mixture.

The present inventors have confirmed that in production of a polyurethane resin from a polyol mixture containing a polyol, a catalyst, and according to need, an additive, a blowing agent, and reinforcing material, and a polyisocyanate component, adding at least one kind of sulfurous compound to a polyol mixture reduced the amount of aldehyde emission from a polyurethane molded part kept at even high temperature. A polyurethane, particularly, a molded polyurethane part, in which the amount of aldehydes (formaldehyde and acetaldehyde) emitted (released) at high temperatures from 65° C. to 80° C. is small is produced by the process of the present invention.

Various studies have been performed to obtain an effective aldehydes-capturing agent or aldehyde modifying agent. Among the known agents are those described below.

In a study on reduction of polyol using NaBH₄ and LiALH₄ as the most typical reducing agent, NaBH₄ showed a good effect for formaldehyde, but showed no effect for acetaldehyde. When a polyol was treated with LiALH₄, acetaldehyde was reversely increased by a high temperature treatment (150° C., 2 Hrs).

When acetaldehyde was added to 150 g of a standard polyol mixture in an amount such that the acetaldehyde was present in a concentration of 10 ppm, 1.0 g of 0.5% aqueous solution of sodium sulfide, sodium hydrogen sulfide, hydroquinone and sodium ascorbate as a typical reducing agent were each added and stirred, then, filled in a 1 L bottle, the concentration of acetaldehyde contained in an upper air layer after storing at 65° C. for 2 hours was examined to find out the effect of each reducing agent added. The reduction rate to the standard one was only 30% (quantitative determination of aldehyde released using Kitagawa type detector 171SC).

It is known that aldehydes and sodium hydrogen sulfite produce an addition compound. However, it is also known that the salt generated is very unstable and it is easily returned to the starting aldehydes by heating in a dilute acid or alkali. It is further known that adding a small amount of sulfuric acid to sodium sulfite produces a sulfonate.

It has been found that when a 0.5% aqueous solution of a sulfurous compound such as sodium sulfite, potassium sulfite, sodium bisulfate, sodium hyposulfite, sodium pyrosulfate, thiosulfate of soda, ammonium thiosulfate and sodium bisulfite, or a phosphorous compound such as sodium phosphate, sodium hypophosphite or one of the sodium phosphonates were added for the amount in solid content to be 5 mg, in the same manner as described above, mixed with 150 g of standard polyol mixture so that acetaldehyde was added in an amount such that the concentration was 10 ppm, and the concentration of acetaldehyde in an upper air layer after storing at 65° C. for 2 hours was examined using Kitagawa type detector 171SC, that only sodium bisulfite exhibited the very excellent aldehyde-capturing effect by showing no detection of aldehyde released in the air.

The present invention makes it possible to produce a polyurethane, particularly a molded part made of polyurethane resin, in which the amount of aldehydes released during storage at high temperature is reduced.

The effect of adding hydrogen sulfite to a polyol mixture was also studied to find out if a reduction in the amount of aldehydes emitted from a polyurethane resin would be obtained. This study confirmed that a polyurethane resin produced from a polyol mixture that included hydrogen sulfite, and a polyisocyanate component, had aldehyde emissions at relatively high temperatures, for example, at 65° C. which were significantly lower than the conventional polyol component to which no hydrogen sulfite had been added. The amount of formaldehyde was reduced by half or to non-detection level. The amount of acetaldehyde was also reduced to levels that were half or less, 1/10 or less in some case than the control. A polyurethane resin in which the amount of aldehydes emitted was remarkably reduced compared to polyurethanes produced with a conventional polyol component was obtained. The same effect was shown at 80° C., though the aldehyde generation level was different.

The present invention does not require elimination of aldehydes from a raw material used to produce the polyurethane resin molded part. Therefore, it is possible to use raw materials containing aldehydes to produce a polyurethane resin molded part in the process of the present invention. This gives polyurethane producers greater freedom in selecting materials for production of polyurethane resin molded parts.

The present invention produces a polyurethane resin in which the amount of aldehydes emitted from a molded part has been remarkably reduced by adding bisulfite to the polyol component used to produce that polyurethane. More specifically, the polyol component used in the practice of the present invention includes at least one polyol, a catalyst, and optionally, an additive, or a blowing agent or reinforcing material. The bisulfite added is not removed thereafter, and it must be dissolved or dispersed in the polyurethane molded part.

To a polyol mixture, one or more sulfurous compounds, i.e. a hydrogen sulfite (also called “bisulfite) or a disulfite (also called “pyrosulfite”) is/are added. A sulfurous compound is preferably a metal salt or an ammonium salt. Examples of the metal in the metal salt include an alkali metal (for example, lithium, sodium, potassium) and an alkaline earth metal (for example, magnesium, calcium, barium).

Specific examples of suitable hydrogen sulfites include sodium hydrogen sulfite, potassium hydrogen sulfite, calcium hydrogen sulfite, magnesium hydrogen sulfite, ammonium hydrogen sulfite, aluminum hydrogen sulfite, zinc hydrogen sulfite and barium hydrogen sulfite.

Specific examples of suitable disulfites include sodium disulfite, potassium disulfite, calcium disulfite, magnesium disulfite, aluminum disulfite, zinc disulfite and ammonium disulfite.

Sulfurous compounds may be a single compound or a mixture of 2 kinds or more thereof.

In the present invention, hydrogen sulfite is a salt containing [HSO₃]⁻. All salts containing this ion are suitable for use in the present invention. Commercially available, typical hydrogen sulfites of alkali metals or ammonium include ammonium hydrogen sulfite, sodium hydrogen sulfite, potassium hydrogen sulfite and calcium hydrogen sulfite.

Disulfite is a salt containing [S₂O₅]⁻. Sodium hydrogen sulfite can be produced by passing sulfur dioxide in a cold saturated aqueous solution of sodium carbonate so that the disulfite separates out. Sodium hydrogen sulfite is present only in an aqueous solution. A solid material coming to precipitation in production or being obtained by isolation from an aqueous solution of sodium hydrogen sulfite is sodium disulfite (also called pyrosulfite: Na₂S₂O₅). To obtain sodium disulfite, when an aqueous solution of sodium disulfite is purchased, or powder of sodium disulfite anhydride is procured, the obtained one is sodium disulfite (Na₂S₂O₅) or, a mixture of sodium disulfite Na₂S₂O₅) and sodium hydrogen sulfite (NaHSO₃).

Similarly, potassium hydrogen sulfite is procured as potassium disulfite (K₂S₂O₅), whose aqueous solution is sometimes treated as potassium hydrogen sulfite. The present inventors procured ammonium hydrogen sulfite in a 50% aqueous solution thereof. For sodium hydrogen sulfite and potassium hydrogen sulfite, the inventors used a product procured as disulfite in its aqueous solution or as is. Therefore, in the present invention, disulfide, hydrogen sulfite, disulfite and pyrosulfite are substantially the same. All salts containing this ion are suitable for use in the present invention.

For example, in a semi-rigid urethane foam formulation containing about 1.5% water as a blowing agent in the polyol component, when 0.7 parts by weight of sodium hydrogen sulfite were to be added, the simplest method of addition was as follows: 0.7 parts by weight of sodium disulfite was added to 1.5 parts by weight of water, after being dissolved, the aqueous solution was added to the polyol component. However, when a sodium hydrogen sulfite aqueous solution is added to a simple long-chain polyether polyol, generally the polyether polyol becomes clouded, and a certain amount of sodium hydrogen sulfite is separated. This is thought to be the same as the case where hydrogen sulfite is added to a polyol mixture containing another polyether polyol, in addition to the first polyether polyol, a catalyst, and according to need, an additive, a blowing agent and reinforcing material. Further, almost all water present in a polyol component reacts with a polyisocyanate to form a urea bond and generates carbon dioxide to form a semi-rigid urethane foam. Hence, almost all water which was added as a sodium hydrogen sulfite aqueous solution is lost in production of a urethane resin. Therefore, it is a very low probability that sodium hydrogen sulfite dispersed and left in a polyurethane molded part is hydrogen sulfite, and disulfate is thought to be highly probable. It is therefore necessary in the practice of the present invention that after adding a sulfurous compound to a polyol mixture, the polyol component be blended with a polyisocyanate component to produce a polyurethane molded part in which this salt is dispersed.

Hydrogen sulfite to be added to a polyol component is desirably ammonium hydrogen sulfite, sodium hydrogen sulfite, potassium hydrogen sulfite or their disulfite, for example, sodium disulfite or potassium disulfite.

For a sulfurous compound to exhibit the effect sought for the present invention, its must be added in an amount such that at least 0.02 parts by weight of sulfurous compound, relative to 100 parts by weight in total of polyol and catalyst, more desirably 0.07 parts by weight or more, and most desirably 0.20 parts by weight or more are present. Simply from the viewpoint of suppressing the generation or release of aldehydes, further, the larger the added amount (e.g., 0.7 parts by weight or 1.5 parts by weight), the higher the effect shown.

However, a sulfurous compound does influence reactivity in forming a polyurethane resin. When the amount of sulfurous compound added is large, the formability or performance of the polyurethane resin including productivity may not be maintained by adding the same amount of catalyst as was used in the original formulation (i.e., the formulation without added sulfurous compound). Therefore, when the amount of sulfurous compound added is large, the original formulation needs to be readjusted. Further, since there is a possibility that a sulfurous compound decomposes at high temperature and generates sulfurous acid gas, the amount of sulfurous compound added must be kept to the necessary minimum. It is preferred that 5.0 parts by weight or less, particularly 2.0 parts by weight or less, be used.

Therefore, the amount of sulfurous compound added is, relative to 100 parts by weight in total of polyol and catalyst, 0.02 to 5.0 parts by weight, preferably 0.02 to 2.0 parts by weight, more preferably 0.07 to 2.0 parts by weight, and most preferably 0.1 to 1.5 parts by weight.

When a sulfurous compound is added to a polyol mixture or component, solubility differs depending on the kind of sulfurous compound(s) or the composition of a polyol mixture or component. Basically, ammonium hydrogen sulfite is most superior in solubility, when the necessary maximum of added amount is added in the present invention. There is a possibility that almost all of a sulfurous compound is separated. However, the reduction (capture) effect of aldehydes emitted from a polyurethane resin is improved roughly in proportion to the added amount of sulfurous compound. Thus in the present invention, there is no need that a sulfurous compound added to a polyol component be dissolved. However, since a commercially available powdery sulfurous compound precipitates right after it is added to a polyol mixture, the reduction (capture) effect of aldehydes is not obtained even in forming a polyurethane molded part.

To obtain the necessary effect in the present invention, it is desirable that the sulfurous compound added be dispersed in a polyol component or mixture as a fine particle. The fine dispersion should exhibit no apparent precipitation after storage for at least in one hour, desirably 12 hours, more desirably after 2 days. Even in the case of precipitation/separation, it is desirable that re-dispersion can be simply done by stirring and mixing. This is necessary to maximize the effect of the present invention. For a sulfurous compound dispersed inside a polyurethane resin, the smaller its particle size, the higher is the probability that it will react with aldehyde(s) to capture the aldehyde(s). If a polyol component or mixture with added sulfurous compound needs stirring/blending at all times, polyurethane production conditions are markedly restricted. It is necessary to ensure dispersibility of the sulfurous compound to such an extent that no precipitation/separation occurs during operation of a stirrer-equipped tank for a polyol component or mixture in a polyurethane production apparatus.

The method of adding a sulfurous compound to a polyol mixture is not particularly limited. When the amount of sulfurous compound added is small, it may dissolve entirely. It is necessary that a sulfurous compound added to a polyol mixture be dispersed homogeneously in the polyol mixture or in a final molded part in as fine a particle size as possible. For a sulfurous compound to be dispersed homogeneously in a polyol mixture, a particle of sulfurous compound dispersed is desirably 20 μm or less, more desirably 10 μm or less, and most desirably 5 μm or less. The lower limit of particle size is 0.01 μm for example, preferably 0.1 μm.

In adding a sulfurous compound to a polyol mixture, a sulfurous compound is preferably in solution or a sulfurous acid composition. Sulfurous acid composition means that a sulfurous compound is homogeneously dispersed as a microparticulate in a component of a polyol mixture (hereinafter referred to as “sulfurous composition”).

A simple method for obtaining a condition such that a sulfurous compound is partially dissolved or homogeneously dispersed in as fine a particle size as possible is to blend it with a polyol mixture or some component of a polyol mixture after the sulfurous compound is dissolved into an aqueous solution. Further, in a formulation without water, for example, an aqueous solution of a phosphorus compound is blended with polyether polyol and stirred. Thereafter, water is removed to prepare a so-called master batch. However, when a sulfurous compound aqueous solution is added to one component with a small amount in a polyol mixture and blended, a separated body immediately precipitates depending on a blend ratio. These precipitated solids generally have a size exceeding 100 μm, so that a sulfurous compound added in such form is not suitable for use in the practice of the present invention.

For example, a 1 weight % salt-added polyol was formed by adding 3.3 g of 30 weight % sodium hydrogen sulfite aqueous solution to 100 g of colorless polyether polyol and allowed to stand for 3 hours, After no precipitation was confirmed regardless of the white turbidity, a dispersed body was examined under a digital microscope to find that there was no particle of 10 μm or more.

Further, polyether polyol prepared similarly by adding 0.3% of potassium disulfite also showed white turbidity, but it was able to be stored without showing precipitation for 3 weeks. A dispersed body was examined under a digital microscope to find that the particles of the sulfurous compound had a size of 5 μm at the largest, and almost all of them were 3 μm or less.

It is therefore possible to produce a condition such that no precipitation is observed even after 3 weeks while holding a white turbid state constant in a state where a sulfurous compound sufficiently micro-dispersed is dispersed in a polyol mixture.

The effect of raising solubility of a sulfurous compound by heating a polyol mixture to produce a condition that the sulfurous compound is dispersed as a fine particle in a polyol mixture was also studied. This method is not, however, desirable because once a sulfurous compound is dissolved) it separates out as the temperature of polyol mixture goes down. This results in the production of a relatively large crystal from the separated sulfurous compound.

The sulfurous composition is liquid or paste-form.

It is preferable that polyether polyol (preferably 10 weight % to 70 weight % relative to the sulfurous composition) and a sulfurous compound be blended, ground/dispersed so that the particle size of the sulfurous compound is 20 μm or less, and the resulting sulfurous composition is added to a polyol mixture or component. The sulfurous composition contains 5 to 70 weight %, preferably, 10 to 50 weight %, more preferably, 20 to 50 weight %, of sulfurous compound.

The sulfurous composition may contain other components (for example, catalyst, crosslinker, additives) of a polyol mixture.

The sulfurous compound which has been finely ground may be dispersed in a component of a polyol mixture.

For example, 40 to 100 parts by weight of glass beads (particle diameter: 1.0 to 3.0 mm) are blended with 100 parts by weight in total of mixture of a sulfurous compound and a polyol, subjected to a vibration treatment by a shaker (LAU disperser: DAS200) for 10 minutes to 2 hours (for example, 30 minutes), to obtain a paste-form dispersed body containing a sulfurous compound ground to 0 μm, preferably 5 μm or less. The polyol mixture obtained by blending this paste-form dispersed body (sulfurous composition) and a component of a polyol mixture (each raw material) shows particularly excellent storage stability and an effect of suppressing the generation of aldehydes.

Equipment suitable for grinding a sulfurous compound finely includes: a ball mill, three-roll mill, high-speed emulsion/dispersion machine equipped with a rotor or the like.

The technique of the present invention can be applied to any polyurethane produced by reacting a polyisocyanate compound and a polyol mixture. For example, a flexible urethane, rigid urethane, semi-rigid urethane, polyurethane elastomer, high density rigid urethane or two-component polyurethane adhesive, two-component polyurethane paint or the like may be produced in accordance with the present invention. Further, the above-described polyurethane resin may be produced in a box or by a continuous forming method, which can be cut to a required shape or sliced for application in a slab foam field as well.

Suitable polyisocyanate compounds for the practice of the present invention include: diphenylmethane diisocyanate, polymethylene polyphenylpolyisocyanate (polymeric MDI), toluene diisocyanate (TDI), hexamethylene diisocyanate, isophorone diisocyanate, naphthalene diisocyanate, and these polyisocyanates blended together, or modified polyisocyanates modified with urethane modification, allophanate modification, carbodiimide (CD) modification, isocyanurate modification, and any mixture thereof.

Polyols suitable for use in the practice of the present invention include: polyhydric alcohols, amines, polyphenols, polyether polyols formed by alkylene oxide addition, or polyester polyols derived from polyhydric alcohols and polycarboxylic acids, or an active hydrogen-containing compound with a low molecular weight called a chain extender and a crosslinker mainly used for adjusting hardness of a flexible polyurethane resin (molecular weight preferably 300 or less, for example, 50 to 299).

Suitable polyether polyols include any of the polyether polyols containing active hydrogen groups of 2 to 8 in a molecule (hydroxyl group-containing compounds such as polypropylene glycol, diethylene glycol, glycerin, trimethylolpropane, pentaerythritol, sorbitol and sucrose; amino group- and hydroxyl group-containing compounds such as triethanolamine and diethanolamine; amino group-containing compounds such as ethylenediamine and diaminotoluene; or toluenediamine, methylenedianiline and xylenediamine, aromatic diamine) to which an alkylene oxide such as ethylene oxide and propylene oxide has been added, having an average molecular weight of 300 to 2000. Among these polyether polyols, are the so-called polymer polyols (a vinyl compound is addition polymerized) and so-called PHD polyols (polyurea or polyhydrazodicarbonamide is dispersed in a polyether polyol) whose effect is the same as the present invention confirmed by the present inventors (Japanese Examined Patent Publication No. JP-A-Sho 55-46654).

Further, as the polyester polyol, there can be used polyester polyol obtained from a polycarboxylic acid and a hydroxyl group-containing compound with a low molecular weight, lactone based polyester obtained by a ring-opening polymerization of caprolactone, polycarbonate polyol, poly(tetramethylene glycol) obtained by a ring-opening polymerization of tetrahydrofuran; and a polyether polyamine obtained by aminating a hydroxyl group of polyether polyol or by hydrolysis of isocyanate prepolymer of polyether polyol, having an active hydrogen equivalent of 80 to 3000.

As the active hydrogen-containing compound with a low molecular weight called a chain extender and/or a crosslinker, there can be used a divalent alcohol with an average molecular weight of 62 to 300, for example, ethylene glycol, propylene glycol, butanediol, hexanediol, neopentyl glycol, diethylene glycol, triethylene glycol, polyethylene glycol, dipropylene glycol and polypropylene glycol; an alcohol with 3 to 8 valences, for example, glycerin, trimethylolpropane, pentaerythritol, sucrose or a polyether polyol that these are added with propylene oxide and ethylene oxide. Further, according to need, there are used a divalent amine, for example, diethyltoluenediamine, t-butyl-toluenediamine, diethyldiaminobenzene, triethyldiaminobenzene and tetraethyldiaminodiphenylmethane; and polyether polyol to which an alkylene oxide has been added. These are described in Japanese Examined Patent Publication Nos. Sho 54-17359, Sho 63-47726 and Hei 1-34527, Japanese Unexamined Patent Publication No. Sho 57-74325, and the like. The amount of the active hydrogen-containing compound with a low molecular weight chain extender and/or crosslinker may be 100 parts by weight or less, for example, 0.1 to 50 parts by weight and preferably 1 to 30 parts by weight relative to 100 parts by weight in total of polyol and catalyst.

Suitable catalysts include: tertiary amines such as triethylenediamine, pentamethyldiethylenetriamine, 1,8-diazabicyclo-5,4,0-undecene-7, dimethylaminoethanol, tetramethylethylenediamine, dimethyl-benzylamine, tetramethylhexamethylenediamine, bis(2-dimethyl-aminoethyl)ether and imidazoles, salts of a tertiary amine and an organic acid; and an organic metal compound such as dibutyltin dilaurate, tin octanoate, dibutyltin diacetate and dibutyltin thiodiacetate. Further, a trimeric catalyst, a metal salt of a carboxylic acid such as, sodium acetate, potassium acetate, can be utilized in producing isocyanurate foam. Further, hydrogen sulfite which is neutralized, and also a hydroxide compound such as sodium hydroxide, potassium hydroxide or calcium hydroxide can be added to increase reactivity or compensate the lowering of urethanization reaction due to the addition of hydrogen sulfite. In this case, the hydroxide to be added promotes a urethanization reaction and exhibits an effect as a catalyst. The amount of catalyst may be 0.001 to 10 parts by weight relative to 100 parts by weight in total of polyol and catalyst.

Other auxiliary agents which may optionally be employed include foam stabilizers, for example, a silicone surfactant; weathering stabilizers, for example, an antioxidant; ultraviolet absorbers and stabilizers, for example, 2,6-di-t-butyl-4-methylphenol, tetrakis[methylene 3-(3,5′-di-t-butyl-4-hydroxyphenyl)-propionate]methane; and coloring agents. As a reinforcing material, glassy, inorganic or mineral fibers, for example, milled glass fiber, wallastonite fiber, processed mineral fiber or flake, for example, mica, glass flake or the like may be used. These are ordinarily added to a polyol mixture. Further, other aldehyde-capturing agents, for example, a hydrazine derivative, may be used concomitantly. The amount of the auxiliary may be 100 parts by weight or less relative to 100 parts by weight in total of polyol and catalyst for example, 0.1 to 50 parts by weight. The amount of the reinforcing material may be 300 parts by weight or less relative to 100 parts by weight in total of polyol and catalyst, for example, 1 to 100 parts by weight.

Suitable blowing agents include: liquid carbon dioxide; a low-boiling hydrocarbon such as pentane or, cyclopentane; a chlorofluorocarbon, for example, HFC134a, HCFC141b, BFC245fa, BC245fc, or BFC365mfc; water; and any mixture thereof. In a system using water as a blowing agent, this water can be used as a solvent in adding a sulfurous compound. A carbonate of an amine compound or a carboxylic acid, for example, formic acid, can also be used as a blowing agent. The amount of the blowing agent may be 20 parts by weight or less relative to 100 parts by weight in total of polyol and catalyst, for example, 0.01 to 10 parts by weight.

In addition to using a reinforcing material, according to need, such as a glassy, inorganic or mineral fiber, for example, milled glass fiber, wallastonite fiber, processed mineral fiber or flake, for example, mica, glass flake or the like, it is possible to obtain a foam by setting a glass mat, glass cloth or the like in a mold beforehand and injecting polyurethane into the mat, cloth or the like. Inorganic fillers such as calcium carbonate, silica, talc, aluminum hydroxide and titanium oxide, or hollow microscopic spheres made of glass, alumina, silas or the like can also be used.

### EXAMPLES

The present invention will be specifically described with reference to Examples and Comparative examples below. Additionally, hereinafter, parts and % are parts by weight and weight %, unless otherwise specified.

### Comparative Example 1

The materials which were combined to produce the polyol component were as follows.
a) 53 parts of polyether polyol (Polyether Polyol A) with a hydroxyl value of 35 mg KOH/g formed by adding propylene oxide and ethylene oxide to glycerin,
b) 35 parts of polymer polyol (Polymer Polyol B) with a hydroxyl value of 20 mg KOH/g formed by adding propylene oxide and ethylene oxide are added to glycerin and having an acrylonitrile and styrene content of 40%,
c) 3.0 parts of polyether polyol (Polyether Polyol C) with a hydroxyl value of 500 mg KOH/g formed by adding propylene oxide to triethanolamine,
d) 4.0 parts of polyether polyol (Polyether Polyol D) with a hydroxyl value of 60 mg KOH/g formed by adding propylene oxide to diamine,
e) 0.5 parts of polyether polyol (Polyether Polyol E) with a hydroxyl value of 630 mg KOH/g formed by adding propylene oxide to ethylenediamine,
f) 0.3 parts of silicone surfactant,
g) 0.4 parts of dimethylethanolamine,
h) 1.83 parts of adhesion improving agent, Baycoll AV2113 (manufactured by Bayer Material Science),
i) 0.75 parts of tertiary amine catalyst A (manufactured by Air Products and Chemicals. Inc),
j) 0.16 parts of Toyocat ET (Toyo Soda Manufacturing Co., Ltd), and,
k) 1.56 parts of water.

100 g of the above-described mixture (component) were employed. This polyol component and a polyisocyanate compound, Sumidur 44V20 (polymeric MDI: manufactured by Sumika Bayer Urethane Co., Ltd.) were each adjusted to a temperature of 25° C. 36 g of Sumidur 44V20 were added to the 100 g of polyol component and blended with a laboratory mixer to examine reactivity. The results are reported in Table 1. Further, 65 g of a reaction mixture prepared in the same manner was poured into an aluminum mold with an area of 20 cm² to a 1.0 cm thickness and heated at a constant temperature of 40° C. After 2 minutes, the polyurethane was taken out of the mold and a molded part (1 cm thickness) was obtained. This molded part was allowed to stand at ambient temperature for 1 week, cut to 10 cm square and weighed. The weight was about 15 g. The average density was 0.15 g/cm³.

This sample was placed in a 10 L Tedler bag in which nitrogen replacement had been repeated twice, sealed, and about 1 L of nitrogen was charged therein. Nitrogen was removed once with an aspirator, 4 L of pure nitrogen gas were fed into the Tedlar bag using a flow meter, and a valve of silicone tube equipped in the Tedlar bag was closed. This Tedlar bag was placed in a circulation type oven set at 65° C. with the valve being closed while a polytetrafluoroethylene tube jointed with the silicone tube was connected to outside through a ceiling hole of the circulation type oven. After heating for 2 hours, 4 L were collected at a speed of 0.1 L/min in an aldehyde collection cartridge (DNPH) (Waters: DNPH Silica long type) and analyzed by a high-speed liquid chromatography (HPLC). The same procedure was repeated without putting a polyurethane sample in the Tedlar bag (“control sample”). The aldehyde emission from the polyurethane sample was determined by taking the difference between the reading obtained from polyurethane-containing bag and the reading from the control sample. The measurements were carried out twice, and the average was defined as the result.

The results were as follows: 0.25 μg of formaldehyde per one piece of semi-rigid polyurethane foam sample (about 15 g) and 0.88 μg of acetaldehyde; also, 0.02 μg formaldehyde per 10 g of polyurethane foam, and was 0.06 μg/g acetaldehyde. The results are reported in Table 1.

### Example 1

A polyol component was prepared from the same materials and under the same conditions as were used in Comparative Example 1, with the exception that in place of the 1.56 parts of water used in Comparative Example 1, a mixture of 0.14 parts of 50% ammonium hydrogen sulfite aqueous solution (bought as a reagent) and 1.49 parts of water were used. When mixed with Sumidur 44V20 (0.07 parts as ammonium hydrogen sulfite) to examine reactivity, it was found that the reactivity was lowered as indicated by a gel time of 53 seconds (rather than 45 seconds as in Comparative Example 1) and a rise time of 72 seconds (rather than the 61 seconds as in Comparative Example 1). The lowering of reactivity not only caused demolding time to be longer in molding a polyurethane resin, but also changed foaming behavior inside a mold for a mixed liquid of a polyol mixture and a polyiso-cyanate compound. This change can pose an adverse influence on flowability of foaming reaction mixture or moldability of polyurethane parts.

### Example 2

A polyol mixture was produced from the same materials and under the same conditions as those used in Example 1 with the exception that the amount of Toyocat ET was increased to 2.3 parts from 0.16 parts. The reactivity was measured to find the same results as were obtained in Comparative Example 1 (i.e., a gel time of 45 second and rise time of 61 seconds). The reactivity did not change even when this polyol mixture was left for one day. Using this polyol mixture, a molded part was produced under the same conditions as those used in Comparative Example 1. The amount of aldehydes emitted from the molded part was measured in the same manner as in Comparative Example 1.

The amount of formaldehyde emission was not different from the blank value measured in a Tedlar bag which contained no polyurethane sample, not more than 0.03 μg of measurement limit value to determine it to be ND (less than measurement limit).

The amount of acetaldehyde emission was 0.75 μg. The evaluation on aldehydes in total of formaldehyde and acetaldehyde showed a reduction of about 34%.

### Example 3

A polyol mixture was prepared from the same materials and in the same manner as described in Comparative Example 1, with the exception that the amount of Toyocat ET added was increased to 0.32 parts from 0.16 parts and that a mixture of 0.4 parts of 50% ammonium hydrogen sulfite aqueous solution (bought as a reagent) and 1.36 parts of water was used instead of component k). Increasing the amount of catalyst (addition of 0.2 parts as ammonium hydrogen sulfite), resulted in a reactivity which was almost the same as that obtained in Comparative Example 1. The amount of formaldehyde emitted was ND (less than measurement limit); the amount of acetaldehyde emitted was 0.63 μg. The evaluation of aldehydes in total of formaldehyde and acetaldehyde showed a reduction of about 44%.

### Examples 4 to 6

In Examples 4 to 6, the amount of ammonium hydrogen sulfite added to the polyol mixture was increased. The results are shown in Table 1.

From comparison of Example 4 and Example 6, it can be seen that in this semi-rigid polyurethane foam molding, addition of 0.71 parts ammonium hydrogen sulfite relative to 100 parts by weight in total of a polyol and a catalyst is sufficient to reduce the amount of aldehydes emitted. In each of Examples 4 and 6, the amount of both formaldehyde and acetaldehyde emitted is near the measurement limit, i.e., they are 1/10 or less compared with Comparative Example 1.

In Examples 5 and 6, addition of 1.56 parts or 1.58 parts of ammonium hydrogen sulfite lowered the reactivity to such an extent that foam formation without addition of catalyst was impossible. Foaming was achieved with addition of catalyst. The reduction of aldehyde emission was, however, maintained in spite of addition of catalyst.

In each of Examples 1-6, the whole amount of aldehyde emission was 0.8 μg or less for a sample of 100 cm². Further the whole emission amount of aldehydes per 1 g of a polyurethane resin (semi-rigid polyurethane foam) was 0.05 μg or less.

TABLE 1
Evaluations by semi-rigid polyurethane foam

| | | Comparative | | | | | | |
|---|---|---|---|---|---|---|---|---|
| | | example 1 | Example 1 | Example 2 | Example 3 | Example 4 | Example 5 | Example 6 |
| Formulation | Amount of ammonium hydrogen sulfite added | 0 | 0.071 | 0.071 | 0.20 | 0.71 | 1.58 | 1.56 |
| | (parts) (relative to 100 parts by weight in total | | | | | | | |
| | of polyol and catalyst) | | | | | | | |
| | Polyether polyol A (parts by weight) | 53 | 53 | 53 | 53 | 53 | 53 | 53 |
| | Polymer polyol B (parts by weight) | 35 | 35 | 35 | 35 | 35 | 35 | 35 |
| | Polyether polyol C (parts by weight) | 3 | 3 | 3 | 3 | 3 | 3 | 3 |
| | Polyether polyol D (parts by weight) | 4 | 4 | 4 | 4 | 4 | 4 | 4 |
| | Polyether polyol E (parts by weight) | 0.5 | 0.5 | 0.5 | 0.5 | 0.5 | 0.5 | 0.5 |
| | Baycoll AV2113 (parts by weight) | 1.83 | 1.83 | 1.83 | 1.83 | 1.83 | 1.83 | 1.83 |
| | Silicone surfactant (parts by weight) | 0.3 | 0.3 | 0.3 | 0.3 | 0.3 | 0.3 | 0.3 |
| | Tertiary amine catalyst A (parts by weight) | 0.75 | 0.75 | 0.75 | 0.75 | 0.75 | 0.75 | 0.75 |
| | Toyocat ET (parts by weight) | 0.16 | 0.16 | 0.23 | 0.32 | 0.86 | 0.16 | 1.56 |
| | Dimethylethanolamine (parts by weight) | 0.3 | 0.3 | 0.3 | 0.3 | 0.3 | 0.3 | 0.3 |
| | Water (parts by weight) | 1.56 | 1.49 | 1.49 | 1.36 | 0.86 | 0.0 | 0.0 |
| | 50% Ammonium hydrogen sulfite aqueous | 0 | 0.14 | 0.14 | 0.4 | 1.4 | 3.12 | 3.12 |
| | solution | | | | | | | |
| | Sumidur 44V20 (parts by weight) | 36.0 | 36.0 | 36.0 | 36.0 | 36.0 | 36.0 | 36.0 |
| | (relative to 100 parts by weight of polyol mixture) | | | | | | | |
| Mixing | Temperature of raw material (polyol | 25/25 | 25/25 | 25/25 | 25/25 | 25/25 | 25/25 | 25/25 |
| | mixture/isocyanate) (° C.) | | | | | | | |
| condition | Stirring speed(rpm) * stirring time (sec) | 3000 * 10 | 3000 * 10 | 3000 * 10 | 3000 * 10 | 3000 * 10 | 3000 * 10 | 3000 * 10 |
| Reactivity | Cream time (sec) | 14 | 14 | 14 | 14 | 13 | >60 | 14 |
| | Gel time (sec) | 45 | 53 | 45 | 44 | 43 | — | 43 |
| | Rise time (sec) | 61 | 72 | 61 | 56 | 51 | — | 51 |
| Amount of | Amount of formaldehyde emission (μg/sample) | 0.25 | — | ND | ND | ND | — | ND |
| aldehyde | Amount of acetaldehyde emission (μg/sample) | 0.88 | — | 0.75 | 0.63 | 0.04 | — | 0.07 |
| emission | Amount of formaldehyde emission (μg/g) | 0.017 | — | ND | ND | ND | — | ND |
| | Amount of acetaldehyde emission (μg/g) | 0.059 | — | 0.050 | 0.042 | 0.003 | — | 0.005 |

Remarks)
ND: Not Detected

### Comparative Example 2

The following materials were combined to obtain the polyol component used in this example:
l) 80 parts of polyether polyol (Polyether Polyol F) with a hydroxyl value of 28 mg KOH/g prepared by addition of propylene oxide and ethylene oxide to glycerin.
m) 20 parts of polymer polyol (Polymer Polyol G) with a hydroxyl value of 18.5 mg KOH/g which is a polyether polyol formed by adding propylene oxide and ethylene oxide to glycerin which has an acrylonitrile and styrene content of about 40%.
n) 2.0 parts of polyether polyol (Polyether Polyol H) with a hydroxyl value of 37 mg KOH/g prepared by adding propylene oxide and ethylene oxide to glycerin.
f) 1.0 parts of silicone surfactant.
h) 0.5 parts of tertiary amine catalyst A (manufactured by Air Products and Chemicals. Inc).
j) 0.1 parts of Toyocat ET (Toyo Soda Manufacturing Co., Ltd), and
k) 3.2 parts of water.

100 g of the above-described polyol mixture and 40 g of a polyisocyanate, Sumidur VT-80 (mixed product of polymeric MDI and TDI: manufactured by Sumika Bayer Urethane Co., Ltd.) were each adjusted to a temperature of 25° C. and blended with a laboratory mixer to examine reactivity. Cream time was 9 seconds, gel time was 72 seconds and rise time was 116 seconds. Further, 520 g of a reaction mixture prepared in the same manner was poured into an aluminum mold with an area of about 30 cm² to a thickness of 10 cm and heated at a constant temperature of 40° C. After 3 minutes, the polyurethane was removed from the mold. A molded part of flexible urethane foam (10 cm thickness) was obtained. This molded part was allowed to stand at ambient temperature for 1 week, cut to a piece having an area of 10 cm² and weighed. The weight was about 55 g. The average density was 0.055 g/cm³.

Using this sample, the amount of aldehydes emitted was measured in the same manner and under the same conditions as were used in Comparative Example 1. The amounts of aldehydes emitted were as follows: 0.25 μg formaldehyde per one piece of flexible polyurethane foam sample (about 55 g), 0.9 μg acetaldehyde; also, 0.005 μg of formaldehyde per 1.0 g of flexible polyurethane foam, and 0.016 μg/g of acetaldehyde. The results are reported in Table 2.

### Examples 7 to 11

The compositions used and the results obtained in Examples 7 to 11 are reported in Table 2.

A molded part was produced in the same manner as in Comparative Example 2, the amount of aldehydes emitted from the polyurethane molded parts were measured in the same manner as in Comparative Example 1.

In Examples 7 and 8, a mixture of 50% ammonium hydrogen sulfite aqueous solution and water was added in place of the 3.2 g of water used in Comparative example 2. The amounts added are shown in Table 2. In Example 9, 0.7 g of powder bought as a reagent of sodium hydrogen sulfite was dissolved in 3.2 parts of water, added and stirred in the same manner as in Comparative Example 2. The reagent of sodium hydrogen sulfite was a mixture of sodium hydrogen sulfite and sodium disulfite. In Examples 10 and 11, 0.7 parts and 1.5 parts of potassium disulfite powders bought as a reagent were dissolved in 3.2 g of water, respectively, added and stirred in the same manner as in Comparative Example 2. All of the solutions were completely solved and clear. However, since Polymer Polyol G was used, it was impossible to visually determine the solubility of the sodium hydrogen sulfite reagent when the aqueous solution was added

When ammonium hydrogen sulfite, sodium hydrogen sulfite and potassium disulfite each were added in an amount ranging from 0.29 parts to 1.44 parts relative to 100 parts by weight in total of polyol and catalyst, an excellent reduction of the amount of aldehyde emitted was found. No big difference was observed when compared with those Examples in which 0.7 parts were used. The generation of formaldehyde was not more than measurement limit, the generation of acetaldehyde was 0.1 μg or less for a sample of about 55 g, showing the reduction effect of 90% or more. In all Examples, the total amount of aldehydes (i.e., formaldehyde plus acetaldehyde) was 0.1 μg or less for a sample of 100 cm². Further, the total aldehyde emission was 0.001 μg or less per 1 g of a polyurethane resin of flexible polyurethane foam.

TABLE 2
Evaluations by flexible urethane foam

| | | Comparative | | | | Example | Example |
|---|---|---|---|---|---|---|---|
| | | Example 2 | Example 7 | Example 8 | Example 9 | 10 | 11 |
| Formulation | Hydrogen sulfite | None | 50% | 50% | Sodium | Potassium | Potassium |
| | | | Ammonium | Ammonium | hydrogen | disulfite | disulfite |
| | | | hydrogen | hydrogen | sulfite | | |
| | | | sulfite aqueous | sulfite aqueous | | | |
| | | | solution | solution | | | |
| | Amount of hydrogen sulfite added (parts by weight) | 0 | 0.29 | 0.66 | 0.68 | 0.68 | 1.44 |
| | (relative to 100 parts by weight in total of polyol | | | | | | |
| | and catalyst) | | | | | | |
| | Polyether polyol F (parts by weight) | 80 | 80 | 80 | 80 | 80 | 80 |
| | Polymer polyol G (parts by weight) | 20 | 20 | 20 | 20 | 20 | 20 |
| | Polyether polyol H (parts by weight) | 2 | 2 | 2 | 2 | 2 | 2 |
| | Silicone surfactant (parts by weight) | 1 | 1 | 1 | 1 | 1 | 1 |
| | Tertiary amine catalyst B (parts by weight) | 0.5 | 1.8 | 3.3 | 1.5 | 0.8 | 1 |
| | Toyocat ET (parts by weight) | 0.1 | 0.1 | 0.1 | 0.1 | 0.1 | 0.1 |
| | Water (parts by weight) | 3.2 | 2.9 | 2.5 | 3.2 | 3.2 | 3.2 |
| | 50% Ammonium hydrogen sulfite aqueous solution | 0 | 0.6 | 1.4 | | | |
| | Sodium hydrogen sulfite (reagent) | | | | 0.7 | | |
| | Potassium disulfite | | | | | 0.7 | 1.5 |
| | Sumidur VT80 (parts by weight) | 40 | 40 | 40 | 40 | 40 | 40 |
| | (relative to 100 parts by weight of polyol mixture) | | | | | | |
| Mixing | Temperature of raw material (polyol mixture/ | 25/25 | 25/25 | 25/25 | 25/25 | 25/25 | 25/25 |
| condition | Sumidur VT80) (° C.) | | | | | | |
| | Stirring speed (rpm) * stirring time (sec) | 3000 * 10 | 3000 * 10 | 3000 * 10 | 3000 * 10 | 3000 * 10 | 3000 * 10 |
| Amount of | Amount of formaldehyde emission (μg/sample) | 0.25 | ND | ND | ND | ND | ND |
| aldehydes | Amount of acetaldehyde emission (μg/sample) | 0.9 | 0.08 | 0.04 | 0.05 | 0.08 | 0.05 |
| emission | Amount of formaldehyde emission (μg/g) | 0.005 | ND | ND | ND | ND | ND |
| | Amount of acetaldehyde emission (μg/g) | 0.016 | 0.001 | 0.001 | 0.001 | 0.001 | 0.001 |

Remarks)
ND: Not Detected

### Examples 12 to 16

Table 3 reports the compositions and the results achieved by using varying amounts of potassium disulfite to reduce aldehyde emissions. The materials used were the same as those which were used in Comparative Example 2. As is has already been observed, potassium disulfite is excellent compared with other hydrogen sulfites with respect to not disturbing a polyurethane reaction. However, the reactivity tends to be lowered with an increase in the amount of potassium disulfite added. Further, foam may tend to be open celled when potassium disulfite is used. After a molded part was obtained in a manner such that the amount of potassium disulfite added relative to 100 parts by weight in total of polyol and catalyst was varied in the same way as Examples 10 and 11, the amount of aldehyde emitted was examined and compared with the results obtained in Comparative Example 2. In Example 12, although there was no change of reactivity when 0.019 parts of potassium disulfite were added, the reduction of aldehyde generation was limited by as much as 25%. This level was determined as a limiting amount to be added to exhibit reduction effects. In Example 13, with addition of 0.68 parts of potassium disulfite, the generation of formaldehyde was already at or below the measurement limit. In Examples 13 through 16, with an increase in the amount of potassium disulfite added, the reduction effect on generation of aldehydes became strong. Solubility of potassium disulfite in polyether polyol was about 0.3 parts as long as it was observed upon adding to the aqueous solution. It was therefore determined that potassium disulfite need not necessarily be solved in a polyol mixture for potassium disulfite to exhibit the reduction in aldehyde emissions effect.

In all Examples, with the exception of Example 12, the whole amount of aldehydes emission in total of formaldehyde and acetaldehyde was 0.9 μg or less for a sample of 100 cm². Further, the whole emission amount was 0.02 μg or less per 1 g of a polyurethane resin (flexible polyurethane foam).

TABLE 3
Evaluations by flexible urethane foam

| | | Comparative | Example | Example | Example | Example | Example |
|---|---|---|---|---|---|---|---|
| | | example 2 | 12 | 13 | 14 | 15 | 16 |
| Formulation | Potassium disulfite (powder) 25% aqueous | None | Potassium | Potassium | Potassium | Potassium | Potassium |
| | solution | | disulfite | disulfite | disulfite | disulfite | disulfite |
| | Amount of potassium disulfite added (parts | 0 | 0.019 | 0.068 | 0.19 | 0.39 | 0.68 |
| | by weight) | | | | | | |
| | (relative to 100 parts by weight in total of polyol | | | | | | |
| | and catalyst) | | | | | | |
| | Polyether polyol F (parts by weight) | 80 | 80 | 80 | 80 | 80 | 80 |
| | Polymer polyol G (parts by weight) | 20 | 20 | 20 | 20 | 20 | 20 |
| | Polyether polyol H (parts by weight) | 2 | 2 | 2 | 2 | 2 | 2 |
| | Silicone surfactant (parts by weight) | 1 | 1 | 1 | 1 | 1 | 1 |
| | Tertiary amine catalyst B (parts by weight) | 0.5 | 0.5 | 0.5 | 0.5 | 0.5 | 0.5 |
| | Toyocat ET (parts by weight) | 0.1 | 0.1 | 0.1 | 0.1 | 0.1 | 0.1 |
| | Water (parts by weight) | 32 | 3.13 | 2.98 | 2.56 | 1.93 | 0.95 |
| | 25% Potassium disulfite aqueous solution (parts | 0.00 | 0.08 | 0.28 | 0.80 | 1.60 | 2.80 |
| | by weight) | | | | | | |
| | Sumidur VT80 (parts by weight relative to 100 | 40 | 40 | 40 | 40 | 40 | 40 |
| | parts by weight of polyol mixture) | | | | | | |
| Mixing | Temperature of raw material (polyol | 25/25 | 25/25 | 25/25 | 25/25 | 25/25 | 25/25 |
| condition | mixture/Sumidur VT80) (° C.) | | | | | | |
| | Stirring speed (rpm) * stirring time (sec) | 3000 * 10 | 3000 * 10 | 3000 * 10 | 3000 * 10 | 3000 * 10 | 3000 * 10 |
| Reactivity | Cream time (sec) | 9 | 9 | 9 | 10 | 10 | 11 |
| | Gel time (sec) | 72 | 73 | 74 | 81 | 100 | 99 |
| | Rise time (sec) | 116 | 116 | 118 | 129 | 157 | 155 |
| Amount of | Amount of formaldehyde emission (μg/sample) | 0.25 | 0.15 | ND | ND | ND | ND |
| aldehydes | Amount of acetaldehyde emission (μg/sample) | 0.9 | 0.73 | 0.9 | 0.6 | 0.33 | 0.23 |
| emission | Amount of formaldehyde emission(μg/g) | 0.005 | 0.003 | ND | ND | ND | ND |
| | Amount of acetaldehyde emission(μg/g) | 0.016 | 0.013 | 0.016 | 0.011 | 0.006 | 0.004 |

Remark)
ND: Not detected

The following materials were mixed to obtain a polyol mixture:
a) 90 parts of polyether polyol (Polyether Polyol A) with a hydroxyl value of 35 mg KOH/g that was formed by adding propylene oxide and ethylene oxide to glycerin,
o) 5.8 parts of ethyleneglycol,
p) 0.3 parts of diethanolamine,
k) 0.35 parts of water,
q) 0.005 parts of organic tin catalyst
j) 1.3 parts of Toyocat ET (manufactured by Toyo Soda Manufacturing Co., Ltd.), and
f) 0.02 parts of silicone surfactant.

200 g of the above-described polyol mixture and 90 g of a polyisocyanate compound, SBU isocyanate 0632 (CD modified: manufactured by Sumika Bayer Urethane Co., Ltd.) were each adjusted to a temperature of 25° C. and blended with a laboratory mixer to examine reactivity. The results are reported in Table 4. Further, 260 g of a reaction mixture prepared in the same manner were poured into an aluminum mold with an area of about 20 cm² to a 1.0 cm thickness which was heated to a constant temperature of 40° C. After 3 minutes, the polyurethane was taken out. A molded part of high-density semi-rigid urethane foam was obtained. This molded part was allowed to stand at ambient temperature for 1 week, cut to 10 cm² and weighed. It weighed about 65 g. The average density was 0.65 g/cm³. Using this sample, the amount of aldehydes emitted was measured in the same manner and under the same conditions as were used in Comparative Example 1. 1.0 μg of formaldehyde per one piece of polyurethane foam sample (about 65 g), and 2.3 μg acetaldehyde were emitted. The amount of formaldehyde emitted was 0.02 μg per 1.0 g of high-density semi-rigid urethane foam (polyurethane resin), and of acetaldehyde was 0.035 μg/g. The results are reported in Table 4.

### Comparative Example 4

To 200 g of the polyol mixture prepared in Comparative Example 3, 3 g of sodium hydrogen sulfite powder bought as a reagent (average particle diameter of 0.5 mm) were added, stirred and left. Almost all salts added precipitated in about 2 minutes. This raw material was stirred again at a low speed for 10 minutes, but almost all salts soon precipitated. After this material was left for one day, it was stirred again, and then stirred with a polyisocyanate compound, and a molded part was obtained in the same manner as in Comparative Example 3. Using this sample, the amount of aldehydes emitted was measured in the same manner and under the same conditions as were used in Comparative Example 1. The amount of formaldehyde emitted per one piece of polyurethane foam sample (about 65 g) was not greater than the measurement limit. No reduction effect on the generation of acetaldehyde was observed.

It is thought that only a minute powder component showed the effect out of the sodium hydrogen sulfite added. When the average diameter of particles of sodium hydrogen sulfite is large, most of them precipitate, hence it seems that the reduction effect on the amount of aldehydes emission is not sufficient.

### Example 17

Due to the little amount of water used, until a particle becomes a particle size capable of being uniformly dispersed when it is added to a polyol mixture, 10 g of sodium hydrogen sulfite powder were added to a polyol mixture beforehand and ground in a mortar while confirming uniform dispersion without precipitation.

1.5 parts of ground product whose uniform dispersion was able to be confirmed was added/stirred to the same polyol mixture as that which was used in Comparative Example 3. The sodium hydrogen sulfite added was uniformly dispersed (average particle diameter of not more than 20 μm) and maintained in the dispersion state. Using this raw material, a molded part was obtained in the same manner as in Comparative Example 3. The amount of aldehydes emitted was measured. The results are reported in Table 4. The reduction effect of 95% or more was shown, the generation of formaldehyde was not more than the measurement limit. The generation of acetaldehyde was also 0.1 μg or less for a sample of about 65 g, and the reduction effect of 95% or more was shown. Further, the whole amount of aldehydes emitted was 0.002 μg per 1 g of high-density semi-rigid urethane foam.

### Example 18

Due to the little amount of water used, compared to the Comparative Examples, the amount of ethylene glycol added as one component in a polyol mixture was lowered to 4.3 parts from 5.8 parts. 100 g each of ethyleneglycol and sodium hydrogen sulfite powder were mixed, subjected to vibration treatment for 30 minutes together with glass beads of 2 mm diameter using a shaker (LAU disperser: DAS 2000), to give a paste-like dispersed product. It was confirmed by a digital microscope VHX-100 manufactured by Keyence Corporation) that the sodium hydrogen sulfite powder was ground to 10 μm or less, and 3.00 parts of this paste-like dispersed product was added to the polyol mixture. Thereafter, a molded part was obtained in the same manner as in Comparative Example 3. The amount of aldehydes emitted was measured. The results are reported in Table 4. The emission of formaldehyde was not more than measurement limit, the generation of acetaldehyde was also 0.1 μg or less for a sample of about 65 g, and the reduction effect of 95% or more was shown. Further, the whole aldehyde emission amount was 0.0004 μg per 1 g of high-density semi-rigid urethane foam (polyurethane resin).

TABLE 4
Evaluations by high-density semi-rigid urethane foam

| | | Comparative | Comparative | Example | Example |
|---|---|---|---|---|---|
| | | example 3 | example 4 | 17 | 18 |
| Formulation | Sodium hydrogen sulfite (powder) | None | Sodium | Sodium | Sodium |
| | | | hydrogen | hydrogen | hydrogen |
| | | | sulfite | sulfite | sulfite |
| | Amount of sodium hydrogen sulfite added (parts by weight) | 0 | 1.54 | 1.54 | 1.54 |
| | (relative to 100 parts by weight in total of polyol and catalyst) | | | | |
| | Polyether polyol A (parts by weight) | 90 | 90 | 90 | 90 |
| | Ethylene glycol (parts by weight) | 5.8 | 5.8 | 5.8 | 4.3 |
| | Diethanolamine (parts by weight) | 0.3 | 0.3 | 0.3 | 0.3 |
| | Silicone surfactant (parts by weight) | 0.02 | 0.02 | 0.02 | 0.02 |
| | Organic tin catalyst (parts by weight) | 0.005 | 0.005 | 0.005 | 0.005 |
| | Toyocat ET (parts by weight) | 1.3 | 1.3 | 1.3 | 1.3 |
| | Water (parts by weight) | 0.35 | 0.35 | 0.35 | 0.35 |
| | Sodium hydrogen sulfite (powder) (parts by weight) | | 1.5 | | |
| | Sodium hydrogen sulfite (ground) (parts by weight) | | | 1.5 | |
| | Sodium hydrogen sulfite (powder) and ethyleneglycol (50:50) | | | | 3.00 |
| | paste-like dispersed product (parts by weight) | | | | |
| | SBU isocyanate 0632 (parts by weight relative to 100 parts by | 45.0 | ← | ← | ← |
| | weight of polyol mixture) | | | | |
| Mixing | Temperature of raw material | 25/25 | 25/25 | 25/25 | 25/25 |
| condition | (polyol mixture/SBU isocyanate 0632 (° C.) | | | | |
| | Stirring speed (rpm) * stirring time (sec) | 3000 * 10 | 3000 * 10 | 3000 * 10 | 3000 * 10 |
| Amount of | Amount of formaldehyde emission (μg/sample) | 1.0 | ND | ND | ND |
| aldehydes | Amount of acetaldehyde emission (μg/sample) | 2.3 | 2.3 | 0.1 | 0.025 |
| emission | Amount of formaldehyde emission (μg/g) | 0.018 | ND | ND | ND |
| | Amount of acetaldehyde emission (μg/g | 0.035 | 0.035 | 0.002 | 0.0004 |

Remark)
ND: Not Detected

### Comparative Example 5

A flexible polyurethane foam sample molded from the same materials and under the same conditions as those used in Comparative Example 2 was measured for the amount of aldehydes emitted in the same manner and under the same conditions as were used in Comparative Example 1 with the exception that the heating condition was increased to 80° C. from 65° C. The amount of formaldehyde emitted was 0.30 μg for a sample of 55 g, and the amount of acetaldehyde emitted was 1.45 μg. With an increase in test temperature, the amount of formaldehyde emission and the amount of acetaldehyde emission were increased 1.5 times and 2 times, respectively.

### Example 19

Using a molded part of flexible polyurethane foam containing 0.39 parts of potassium disulfite produced from the same materials in the same manner as was used in Example 15 relative to 100 parts by weight in total of polyol and catalyst, the amount of aldehydes emitted was measured in the same manner and under the same conditions as those used in Comparative Example 5. The generation of formaldehyde was no greater than the measurement limit for a sample of 55 g, the generation of acetaldehyde was 1.39 μg. It was confirmed that the amount of formaldehyde emission was able to be reduced sufficiently even with an increase in a heating test temperature. The reduction effect of acetaldehyde generation was 20%. Further, the whole emission amount was 0.03 μg per 1 g of flexible urethane foam (polyurethane resin).

### Example 20

Using a molded part of flexible polyurethane foam containing 0.68 parts of potassium disulfite produced from the same materials and in the same manner as the foam described in Example 16 relative to 100 parts by weight in total of polyol and catalyst, the amount of aldehydes emitted was measured in the same manner and under the same conditions as those used in Comparative Example 5. The generation of formaldehyde was no greater than the measurement limit for a sample of 55 g, the generation of acetaldehyde was 0.64 μg. The reduction effect was 65%. Further, the total amount of emissions was 0.01 g per 1 g of flexible urethane foam (polyurethane resin). It was confirmed that the reduction of the aldehydes emission was effective even at a heating test temperature of 80° C.

Although the invention has been described in detail in the foregoing for the purpose of illustration, it is to be understood that such detail is solely for that purpose and that variations can be made therein by those skilled in the art without departing from the spirit and scope of the invention, except as it may be limited by the claims.

What is claimed is:

1. A process for the production a polyurethane resin comprising reacting
(a) a polyol component comprising
(i) at least one polyol,
(ii) a catalyst,
and
(iii) at least one sulfur-containing compound selected from hydrogen sulfites and disulfites
with
(b) a polyisocyanate.

2. The process of claim 1 in which the sulfur-containing compound comprises an alkali metal salt, an alkaline earth metal salt, an ammonium salt or a mixture thereof.

3. The process of claim 1 in which the sulfur-containing compound is selected from the group consisting of sodium hydrogen sulfite, potassium hydrogen sulfite, calcium hydrogen sulfite, magnesium hydrogen sulfite, aluminum hydrogen sulfite, zinc hydrogen sulfite, barium hydrogen sulfite, ammonium hydrogen sulfite, sodium disulfite, potassium disulfite, calcium disulfite, magnesium disulfite, ammonium disulfite, and mixtures thereof.

4. The process of claim 1 in which the sulfur-containing compound is included in an amount of from 0.02 to 2.0 parts by weight per 100 parts by weight polyol plus catalyst.

5. The process of claim 1 in which the sulfur-containing compound is an aqueous solution of the sulfur-containing compound.

6. The process of claim 1 in which the sulfur-containing compound has a particle size of 20 μm or less and is dispersed in the polyol component.

7. The process of claim 6 in which the sulfur-containing compound is produced by mixing/grinding the sulfur-containing compound in the polyol.

8. A molded polyurethane part produced by the process of claim 1 in which aldehyde emissions from the molded part after being maintained at 65° C. for 2 hours is 0.005 μg or less per 1 g of polyurethane resin.

9. A molded polyurethane part produced by the process of claim 1 having a density of 0.03 to 1.8 g/m³ and a thickness of 0.01 mm to 20 cm in which total formaldehyde and acetaldehyde emissions from a 10 cm by 10 cm square section of the part having a thickness of 10 cm or less is 0.5 g or less after being maintained at 65° C. for 2 hours.

10. A molded polyurethane part produced by the process of claim 1 in which aldehyde emissions from the molded part after being maintained at 80° C. for 2 hours is 0.01 μg or less per 1 g of polyurethane resin.
